(19) United States
(12) Patent Application Publication
(10) Pub. No.: US 2020/0143176 A1
(43) Pub. Date: May 7, 2020

(54) ADVANCED DRIVER ASSISTANCE SYSTEM AND METHOD

(71) Applicant: Huawei Technologies Co., Ltd., Shenzhen (CN)

(72) Inventors: Atanas BOEV, Munich (DE); Onay URFALIOGLU, Munich (DE); Panji SETIAWAN, Munich (DE)

(21) Appl. No.: 16/735,192

(22) Filed: Jan. 6, 2020

Related U.S. Application Data
(63) Continuation of application No. PCT/EP2017/066877, filed on Jul. 6, 2017.

(51) Int. Cl. G06K 9/00; B60W 40/072; G06K 9/62

(52) U.S. Cl. CPC G06K 9/00798; G06K 9/6215; G06K 9/6202; B60W 40/072

(57) ABSTRACT

An advanced driver assistance system is configured to detect lane markings in a perspective image of a road in front of the vehicle. The perspective image of the road is separated into horizontal stripes corresponding to different road portions at different average distances from the vehicle. Features are extracted from the plurality of horizontal stripes using a plurality of kernels.

### CROSS-REFERENCE TO RELATED APPLICATIONS

This application is a continuation of International Application No. PCT/EP2017/066877, filed on Jul. 6, 2017, the disclosure of which is hereby incorporated by reference in its entirety.

### TECHNICAL FIELD

The invention relates to the field of image processing. More specifically, the invention relates to an advanced driver assistance system for detecting lane markings.

### BACKGROUND

Advanced driver assistance systems (ADASs), which either alert the driver in dangerous situations or take an active part in the driving, are gradually being inserted into vehicles. Such systems are expected to grow more and more complex towards full autonomy during the near future. One of the main challenges in the development of such systems is to provide an ADAS with road and lane perception capabilities.

Road color and texture, road boundaries and lane markings are the main perceptual cues for human driving. Semi and fully autonomous vehicles are expected to share the road with human drivers, and would therefore most likely continue to rely on the same perceptual cues humans do. While there could be, in principle, different infrastructure cuing for human drivers and vehicles (e.g. lane markings for humans and some form of vehicle-to-infrastructure communication for vehicles) it is unrealistic to expect the huge investments required to construct and maintain such double infrastructure, with the associated risk in mismatched marking. Road and lane perception via the traditional cues remains therefore the most likely path for autonomous driving.

Road and lane understanding includes detecting the extent of the road, the number and position of lanes, merging, splitting and ending lanes and roads, in urban, rural and highway scenarios. Although much progress has been made in recent years, this type of understanding is beyond the reach of current perceptual systems.

There are several sensing modalities used for road and lane understanding, including vision (i.e. one video camera), stereo, LIDAR, vehicle dynamics information obtained from car odometry or an Inertial Measurement Unit (IMU) with global positioning information obtained using the Global Positioning System (GPS) and digital maps. Vision is the most prominent research area in lane and road detection due to the fact that lane markings are made for human vision, while LIDAR and global positioning are important complements.

Generally, lane and road detection in an ADAS includes the extraction of low level features from an image (also referred to as “feature extraction”). For road detection, these typically include color and texture statistics allowing road segmentation, road patch classification or curb detection. For lane detection, evidence for lane marks is collected.

Vision based feature extraction methods rely on the usage of filters which often are based on a kernel and, thus, require specifying a kernel scale. A lot of conventional approaches, such as disclosed by McCall, J. and Trivedi, M., “Video-based lane estimation and tracking for driver assistance: Survey, system, and evaluation”, in IEEE Trans. On Intelligent Transportation Systems 7, vol. 7, no. 1, 2006, choose to work in the inverse perspective image domain or “bird's eye view” domain (non-distorted domain) to avoid having kernels varying in size. In that domain, the original image (distorted image) has been transformed in a manner that compensates the perspective distortion.

Other conventional approaches, such as disclosed by Huang et al., “Finding multiple lanes in urban road networks with vision and LIDAR”, in Autonomous Robots, vol. 26, pp. 103-122, 2009, adopt the other approach of performing the filtering in the (perspective) image domain where the perspective distortion is compensated by having kernels varying in size. A particular kernel shape for extracting features is proposed by Huang et al.

Although the conventional approaches described above, provide some advantages there is still room for improvement. Thus, there is a need for an improved advanced driver assistance system as well as a corresponding method.

### SUMMARY

It is an object of the invention to provide an improved advanced driver assistance system as well as a corresponding method.

The foregoing and other objects are achieved by the subject matter of the independent claims. Further implementation forms are apparent from the dependent claims, the description and the figures.

According to a first aspect the invention relates to an advanced driver assistance system (ADAS) for a vehicle, wherein the ADAS is configured to detect lane markings in a perspective image of a road in front of the vehicle. The ADAS comprises a feature extractor configured to separate the perspective image of the road into a plurality of horizontal stripes, wherein each horizontal stripe of the perspective image corresponds to a different road portion at a different average distance from the vehicle. The feature extractor is further configured to extract features (e.g. coordinates of lane markings) from the plurality of horizontal stripes using a plurality of kernels, each kernel being associated with a kernel width, by processing a first horizontal stripe corresponding to a first road portion at a first average distance using a first kernel associated with a first kernel width, a second horizontal stripe corresponding to a second road portion at a second average distance using a second kernel associated with a second kernel width and a third horizontal stripe corresponding to a third road portion at a third average distance using a third kernel associated with a third kernel width, wherein the first average distance is smaller than the second average distance and the second average distance is smaller than the third average distance and wherein the ratio of the first kernel width to the second kernel width is larger than the ratio of the second kernel width to the third kernel width.

Thus, an improved ADAS is provided. The improved ADAS uses feature extraction with a variable kernel width, wherein the kernel width decreases with a lower rate compared to, for instance, the kernel height to take into account the increased contribution of the camera sensor noise as the features sizes get smaller.

In a further implementation form of the first aspect, the first horizontal stripe is adjacent to the second horizontal stripe and the second horizontal stripe is adjacent to the third horizontal stripe.

In a further implementation form of the first aspect, each kernel of the plurality of kernels is defined by a plurality of kernel weights and each kernel comprises left and right outer kernel portions, left and right intermediate kernel portions and a central kernel portion, including left and right central kernel portions, wherein for each kernel the associated kernel width is the width of the whole kernel, i.e. the sum of the widths of the two outer kernel potions, the two intermediate kernel portions and the central kernel portion.

In a further implementation form of the first aspect, for detecting, i.e. extracting a feature the feature extractor is further configured to determine for each horizontal stripe a respective average intensity in the left and right central kernel portions, the left and right intermediate kernel portions and the left and right outer kernel portions using a respective convolution operation on the basis of the corresponding kernel and to compare a respective result of the respective convolution operation with a respective threshold value. The convolution output may be pre-processed by a signal processing operation (e.g., median filtering) prior to the comparison.

In a further implementation form of the first aspect, for a currently processed horizontal stripe identified by a stripe index r the feature extractor is configured to determine the width of the central kernel portion d_{C}(r), the widths of the left and right intermediate kernel portions d_{B}(r) and the widths of the left and right outer kernel portions d_{A}(r) on the basis of the following equations:

d_{A}(r)=L′ₓ(r); d_{B}(r)=L′_{y}(r); d_{C}(r)=d_{A}(r)−d_{B}(r)+1; d_{C1}(r)=d_{C2}(r)=d_{C}(r)/2,

Kr(r)=d_{B}(r)=L′_{y}(r); d_{C}(r)≥1,

wherein L′ₓ(r) denotes a distorted expected width of the lane marking, L′_{y}(r) denotes a height of the currently processed horizontal stripe, d_{C1}(r) denotes a width of the left central kernel portion, d_{C2}(r) denotes a width of the right central kernel portion and Kr(r) denotes the height of the currently processed horizontal stripe.

In a further implementation form of the first aspect, for the currently processed horizontal stripe identified by the stripe index r the feature extractor is configured to determine the plurality of kernel weights on the basis of the following equations:

$${w}_{A 1} ( r ) = {w}_{A 2} ( r ) = \frac{- 0.5}{{d}_{A} ( r ) \cdot {d}_{B} ( r )} ; {w}_{B} ( r ) = 0 ;$$

$${w}_{C 1} ( r ) = {w}_{C 2} ( r ) = \frac{1}{{d}_{B} ( r ) \cdot [ {d}_{C 1} ( r ) + {d}_{C 2} ( r ) ]} ,$$

wherein w_{A1}(r) denotes the kernel weight of the left outer kernel portion, w_{A2}(r) denotes the kernel weight of the right outer kernel portion, w_{B}(r) denotes the kernel weight of the left and right intermediate kernel portions, w_{C1}(r) denotes the kernel weight of the left central kernel portion and w_{C2}(r) denotes the kernel weight of the right central kernel portion.

Thus, an improved parametrized kernel is provided, which is configured to detect the difference of the average intensity between the lane marking and its surroundings.

In a further implementation form of the first aspect, for the currently processed horizontal stripe identified by the stripe index r the feature extractor is configured to determine the plurality of kernel weights on the basis of the following equations:

$${w}_{A 1} ( r ) = {w}_{A 2} ( r ) = 0 ; {w}_{B} ( r ) = 0 ;$$

$${w}_{C 1} ( r ) = \frac{1}{{d}_{B} ( r ) \cdot {d}_{C 1} ( r )} ;$$

$${w}_{C 2} ( r ) = \frac{- 1}{{d}_{B} ( r ) \cdot {d}_{C 2} ( r )} ,$$

wherein w_{A1}(r) denotes the kernel weight of the left outer kernel portion, w_{A2}(r) denotes the kernel weight of the right outer kernel portion, w_{B}(r) denotes the kernel weight of the left and right intermediate kernel portions, w_{C1}(r) denotes the kernel weight of the left central kernel portion and w_{C2}(r) denotes the kernel weight of the right central kernel portion.

Thus, an improved parametrized kernel is provided, which is configured to detect the uniformity of the intensity in the region of the lane marking.

In a further implementation form of the first aspect, for the currently processed horizontal stripe identified by the stripe index r the feature extractor is configured to determine the plurality of kernel weights on the basis of the following equations:

$${w}_{A 1} ( r ) = \frac{- 1}{{d}_{A} ( r ) \cdot {d}_{B} ( r )} ;$$

$${w}_{A 2} ( r ) = {w}_{B} ( r ) = 0 ;$$

$${w}_{C 1} ( r ) = {w}_{C 2} ( r ) = \frac{1}{{d}_{B} ( r ) \cdot [ {d}_{C 1} ( r ) + {d}_{C 2} ( r ) ]} ,$$

wherein w_{A1}(r) denotes the kernel weight of the left outer kernel portion, w_{A2}(r) denotes the kernel weight of the right outer kernel portion, w_{B}(r) denotes the kernel weight of the left and right intermediate kernel portions, w_{C1}(r) denotes the kernel weight of the left central kernel portion and w_{C2}(r) denotes the kernel weight of the right central kernel portion.

Thus, an improved parametrized kernel is provided, which is configured to detect the difference between the mean intensity of the lane and road surface to the left of the lane marking.

In a further implementation form of the first aspect, for the currently processed horizontal stripe identified by the stripe index r the feature extractor is configured to determine the plurality of kernel weights on the basis of the following equations:

$${w}_{A 2} ( r ) = \frac{- 1}{{d}_{A} ( r ) \cdot {d}_{B} ( r )} ;$$

$${w}_{A 1} ( r ) = {w}_{B} ( r ) = 0 ;$$

$${w}_{C 1} ( r ) = {w}_{C 2} ( r ) = \frac{1}{{d}_{B} ( r ) \cdot [ {d}_{C 1} ( r ) + {d}_{C 2} ( r ) ]} ,$$

wherein w_{A1}(r) denotes the kernel weight of the left outer kernel portion, w_{A2}(r) denotes the kernel weight of the right outer kernel portion, w_{B}(r) denotes the kernel weight of the left and right intermediate kernel portions, w_{C1}(r) denotes the kernel weight of the left central kernel portion and w_{C2}(r) denotes the kernel weight of the right central kernel portion.

Thus, an improved parametrized kernel is provided, which is configured to detect the difference between the mean intensity of the lane and road surface to the right of the lane marking.

In a further implementation form of the first aspect, for the currently processed horizontal stripe identified by the stripe index r the feature extractor is configured to determine the plurality of kernel weights on the basis of the distorted expected width of the lane marking L′ₓ(r) and the height of the currently processed horizontal stripe L′_{y}(r).

In a further implementation form of the first aspect, for the currently processed horizontal stripe identified by the stripe index r the feature extractor is configured to determine the width of the central kernel portion d_{C}(r), the widths of the left and right intermediate kernel portions d_{B}(r) and the widths of the left and right outer kernel portions d_{A}(r) on the basis of the distorted expected width of the lane marking L′ₓ(r) and the height of the currently processed horizontal stripe L′_{y}(r) and to determine the plurality of kernel weights on the basis of the width of the central kernel portion d_{C}(r), the widths of the left and right intermediate kernel portions d_{B}(r) and the widths of the left and right outer kernel portions d_{A}(r).

In a further implementation form of the first aspect, the system further comprises a stereo camera configured to provide the perspective image of the road in front of the vehicle as a stereo image having a first channel and a second channel.

In a further implementation form of the first aspect, the feature extractor is configured to independently extract features from the first channel of the stereo image and the second channel of the stereo image and wherein the system further comprises a unit configured to determine those features, which have been extracted from both the first channel and the second channel of the stereo image.

According to a second aspect the invention relates to a corresponding method of operating an advanced driver assistance system for a vehicle, wherein the advanced driver assistance system is configured to detect lane markings in a perspective image of a road in front of the vehicle. The method comprises the steps of: separating the perspective image of the road into a plurality of horizontal stripes, wherein each horizontal stripe of the perspective image corresponds to a different road portion at a different average distance from the vehicle; and extracting features from the plurality of horizontal stripes using a plurality of kernels, each kernel being associated with a kernel width, by processing a first horizontal stripe corresponding to a first road portion at a first average distance using a first kernel associated with a first kernel width, a second horizontal stripe corresponding to a second road portion at a second average distance using a second kernel associated with a second kernel width and a third horizontal stripe corresponding to a third road portion at a third average distance using a third kernel associated with a third kernel width, wherein the first average distance is smaller than the second average distance and the second average distance is smaller than the third average distance and wherein the ratio of the first kernel width to the second kernel width is larger than the ratio of the second kernel width to the third kernel width.

The method according to the second aspect of the invention can be performed by the ADAS according to the first aspect of the invention. Further features of the method according to the second aspect of the invention result directly from the functionality of the ADAS according to the first aspect of the invention and its different implementation forms

According to a third aspect the invention relates to a computer program comprising program code for performing the method according to the second aspect when executed on a computer.

The invention can be implemented in hardware and/or software.

### BRIEF DESCRIPTION OF THE DRAWINGS

Further embodiments of the invention will be described with respect to the following figures, wherein:

FIG. 1 shows a schematic diagram illustrating an advanced driver assistance system according to an embodiment;

FIG. 2 shows a schematic diagram illustrating different aspects of an advanced driver assistance system according to an embodiment;

FIG. 3 shows a schematic diagram illustrating a plurality of kernels implemented in an advanced driver assistance system according to an embodiment;

FIG. 4 shows a schematic diagram illustrating different aspects of an advanced driver assistance system according to an embodiment;

FIG. 5 shows a diagram of two graphs illustrating the adjustment of the kernel width implemented in an advanced driver assistance system according to an embodiment in comparison to a conventional adjustment;

FIG. 6 shows a schematic diagram illustrating processing steps implemented in an advanced driver assistance system according to an embodiment;

FIG. 7 shows a schematic diagram illustrating processing steps implemented in an advanced driver assistance system according to an embodiment; and

FIG. 8 shows a schematic diagram illustrating a method of operating an advanced driver assistance system according to an embodiment.

In the various figures, identical reference signs will be used for identical or at least functionally equivalent features.

### DETAILED DESCRIPTION OF EMBODIMENTS

In the following description, reference is made to the accompanying drawings, which form part of the disclosure, and in which are shown, by way of illustration, specific aspects in which the invention may be placed. It is understood that other aspects may be utilized and structural or logical changes may be made without departing from the scope of the invention. The following detailed description, therefore, is not to be taken in a limiting sense, as the scope of the invention is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

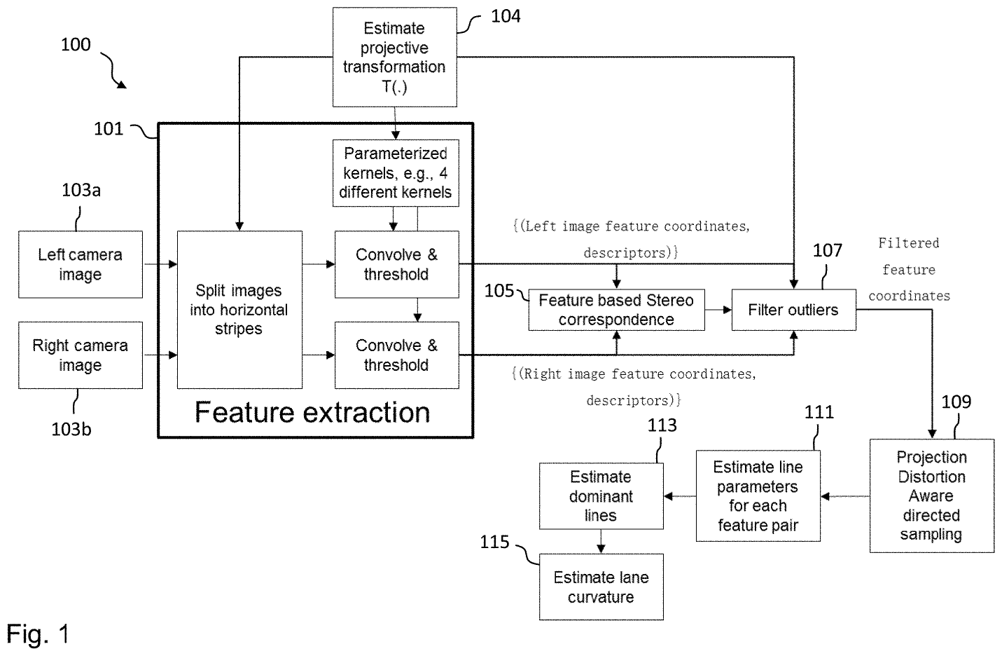

FIG. 1 shows a schematic diagram of an advanced driver assistance system (ADAS) 100 according to an embodiment for a vehicle. The advanced driver assistance system (ADAS) 100 is configured to detect lane markings in a perspective image of a road in front of the vehicle.

In the embodiment shown in FIG. 1, the ADAS 100 comprises a stereo camera configured to provide a stereo image having a first channel or left camera image 103a and a second channel or right camera image 103b. The stereo camera can be installed on a suitable position of the vehicle such that the left camera image 103a and the right camera image 103b provide at least partial views of the environment in front of the vehicle, e.g. a portion of a road. The exact position and/or orientation of the stereo camera of the ADAS 100 defines a camera projection parameter θ.

As illustrated in FIG. 1, the ADAS 100 further comprises a feature extractor 101, which is configured to extract features from the perspective image(s), such as the left camera image 103a and the right camera image 103b provided by the stereo camera. In an embodiment, the features extracted by the feature extractor 101 comprise coordinates of lane markings on the road shown in the perspective image(s).

As illustrated in FIG. 1, the feature extractor 101 of the ADAS 100 is configured to separate the perspective image(s) of the road into a plurality of horizontal stripes, wherein each horizontal stripe of the perspective image corresponds to a different road portion at a different average distance from the vehicle. The feature extractor 101 is further configured to extract features from the plurality of horizontal stripes on the basis of a plurality of kernels, wherein each kernel is associated with a kernel width.

As will be described in more detail further below, the feature extractor 101 is configured to decrease the kernel width with a lower rate compared to, for instance, the kernel height to take into account the increased contribution of the camera sensor noise as the features sizes get smaller. Differently put, the feature extractor 101 is configured to extract features from the plurality of horizontal stripes on the basis of the plurality of kernels by processing a first horizontal stripe corresponding to a first road portion at a first average distance from the vehicle using a first kernel associated with a first kernel width, a second horizontal stripe corresponding to a second road portion at a second average distance from the vehicle using a second kernel associated with a second kernel width and a third horizontal stripe corresponding to a third road portion at a third average distance from the vehicle using a third kernel associated with a third kernel width, wherein the first average distance is smaller than the second average distance and the second average distance is smaller than the third average distance and wherein the ratio of the first kernel width to the second kernel width is larger than the ratio of the second kernel width to the third kernel width. As will be appreciated, for the conventional linear variation of the kernel width the ratio of the first kernel width to the second kernel width would be equal to the ratio of the second kernel width to the third kernel width, i.e. constant. Thus, the feature extractor 100 of the ADAS 100 can be regarded to vary the kernel width on the basis of a dependency that varies more strongly than a linear dependency.

In an embodiment, the feature extractor 101 is further configured to perform convolution operations and compare the respective result of a respective convolution operation with a respective threshold value for extracting the features, in particular coordinates of the lane markings. Mathematically, such a convolution operation can be described by the following equation for a 2-D discrete convolution:

$$O ( i , j ) = {\sum }_{m = 0}^{Kr - 1} {\sum }_{n = 0}^{Kc - 1} K ( m , n ) \times I ( i - m , j - n )$$

wherein the kernel K is a matrix of the size (Kr×Kc) or (Kernel row or height×Kernel column or width) and I(i,j) and O(i,j) denote the respective arrays of input and output image intensity values. The feature extractor 101 of the ADAS 100 can be configured to perform feature extraction on the basis of a horizontal 1-D kernel K, i.e. a kernel with a kernel matrix only depending on m (i.e. the horizontal direction) but not on n (i.e. the vertical direction).

In the exemplary embodiment shown in FIG. 1, the features extracted by the feature extractor 101 are provided to a unit 105 configured to determine those features, which have been extracted from both the left camera image 103a and the right camera image 103b of the stereo image. Only these matching features determined by the unit 105 are passed on to a filter unit 107 configured to filter outliers. The filtered feature coordinates are processed by further units 109, 111, 113 and 115 of the ADAS 100 for, essentially, estimating the curvature of a detected lane.

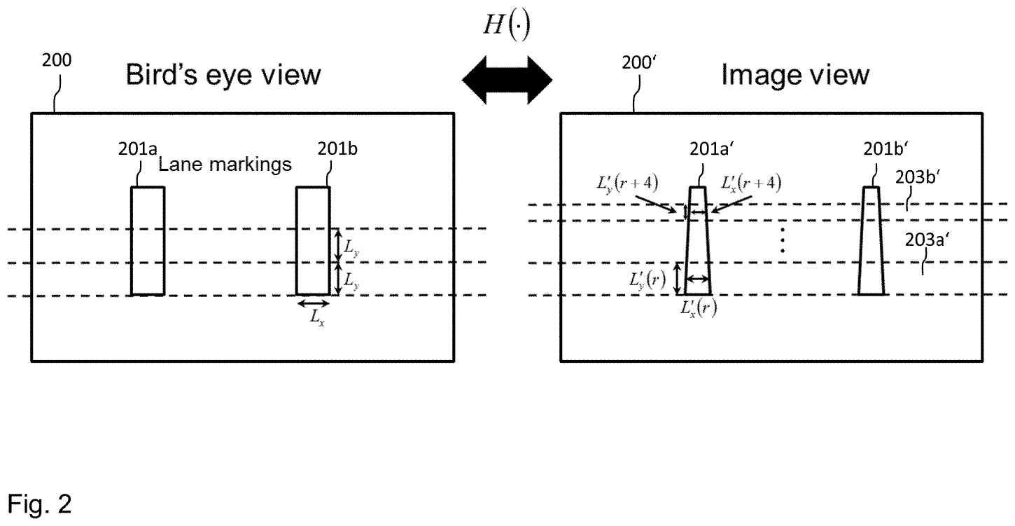

As illustrated in FIG. 1, the ADAS 100 can further comprise a unit 104 for performing a transformation between the bird's eye view and a perspective view and vice versa. FIG. 2 illustrates the relation between a bird's eye view 200 and a corresponding perspective image view 200′ of an exemplary environment in front of a vehicle, namely a road comprising two exemplary lane markings 201a, b and 201a′, b′, respectively.

The geometrical transformation from the bird's eye view, i.e. the non-distorted view 200 to the perspective image view, i.e. the distorted view 200′ is feasible through a transformation matrix H which maps each point of the distorted domain into a corresponding point of the non-distorted domain and vice versa, as the transformation operation is invertible.

Lₓ and L_{y} are the non-distorted expected width of lane marking and sampling step, respectively. They may be obtained from the camera projection parameter Θ, the expected physical width Ω of the lane marking, and the expected physical gap Ψ between the markings of a dashed line.

L_{y}=ƒ(Θ,Ω,Ψ)

Lₓ=ƒ(Θ,Ω,Ψ)

Each horizontal stripe of index r in the image view has the height of a distorted sampling step L′_{y}(r) which corresponds to the non-distorted sampling step, i.e. L_{y}.

The expected width of lane marking at stripe r is denoted by a distorted expected width L′ₓ(r) which corresponds to the non-distorted expected width of lane marking Lₓ. The geometrical transformation from the distorted domain (original image) to the non-distorted domain (bird's eye view) is feasible through a transformation matrix H which maps each point of the distorted domain into a corresponding point of the non-distorted domain. The operation is invertible.

The filtering is done block-wise and row-wise where the proposed kernel height corresponds to the height and the kernel width is adjusted based on the parameters L′_{y}(r) and L′ₓ(r). Since these parameters are constant for each stripe, the kernel size will also be constant for a given stripe. As will be described later, the kernel width can be divided into several regions or sections.

As illustrated in the perspective image view 200′ of FIG. 2 and as already mentioned in the context of FIG. 1, the feature extractor 101 of the ADAS 100 is configured to separate the exemplary perspective input image 200′ into a plurality of horizontal stripes. In FIG. 2, two exemplary horizontal stripes are illustrated, namely a first exemplary horizontal stripe 203a′ identified by first stripe identifier r as well as a second exemplary horizontal stripe 203b′ identified by a second stripe identifier r+4. In the exemplary embodiment shown in FIG. 2, the second exemplary horizontal stripe 203b′ is above the first exemplary horizontal stripe 203a′ and, thus, provides an image of a road portion, which has a larger average distance from the camera of the ADAS 100 than a road portion covered by the first exemplary horizontal stripe 203a′.

As will be appreciated and as illustrated in FIG. 2, due to distortion effects the horizontal width L′ₓ(r) of the lane marking 201a′ within the horizontal stripe 203a′ is larger than the horizontal width L′ₓ(r+4) of the lane marking 201a′ within the horizontal stripe 203b′. Likewise, the vertical height L′_{y}(r) of the horizontal stripe 203a′ is larger than the vertical height L′_{y}(r+4) of the horizontal stripe 203b′.

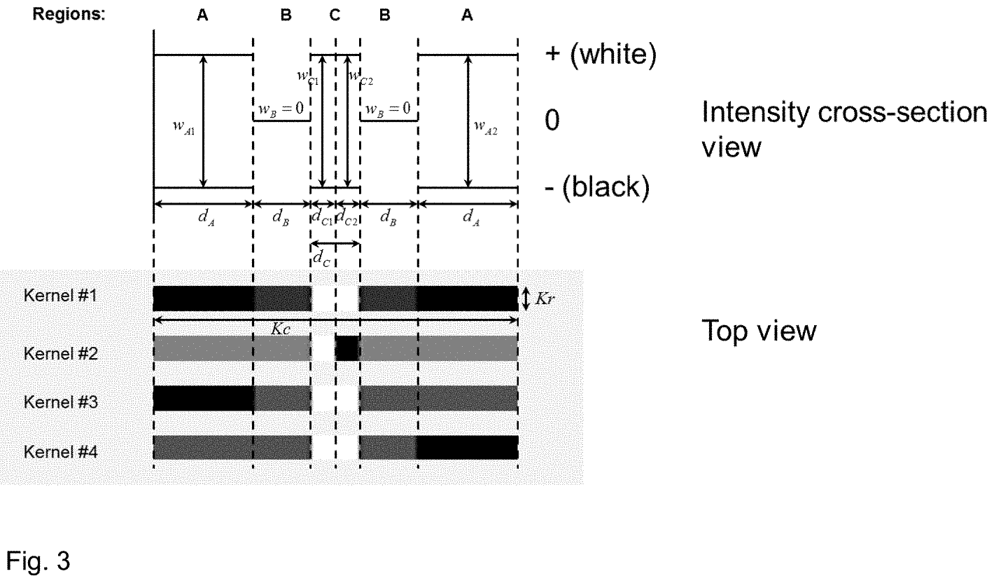

FIG. 3 shows a schematic diagram illustrating a set of four kernels, referred to as kernel #1 to #4 in FIG. 3. One or more of the kernels illustrated in FIG. 3 can be implemented in the feature extractor 101 of the ADAS 100 according to an embodiment. As illustrated in FIG. 3, each kernel is defined by a plurality of kernel weights and comprises left and right outer kernel portions or regions A, left and right intermediate kernel portions or regions B and a central kernel portion or region C, including left and right central kernel portions.

In an embodiment, for a currently processed horizontal stripe identified by a stripe index r the feature extractor 101 of the ADAS 100 is configured to determine the width of the central kernel portion d_{C}(r), the widths of the left and right intermediate kernel portions d_{B}(r) and the widths of the left and right outer kernel portions d_{A}(r) on the basis of the following equations:

d_{A}(r)=L′ₓ(r); d_{B}(r)=L′_{y}(r); d_{C}(r)=d_{A}(r)−d_{B}(r)+1; d_{C1}(r)=d_{C2}(r)=d_{C}(r)/2,

Kr(r)=d_{B}(r)=L′_{y}(r); d_{C}(r)≥1,

wherein L′ₓ(r) denotes a distorted expected width of the lane marking, L′_{y}(r) denotes a height of the currently processed horizontal stripe, d_{C1}(r) denotes a width of the left central kernel portion, d_{C2}(r) denotes a width of the right central kernel portion and Kr(r) denotes the height of the currently processed horizontal stripe.

The respective width of the left and right outer kernel portions d_{A}(r) can be based on the smallest expected gap between closely spaced lane markings. In the embodiment above, it is assumed that d_{A}(r) equals L′ₓ(r). In another embodiment, d_{A}(r) can be a fraction of L′ₓ(r), for instance L′ₓ(r)/2.

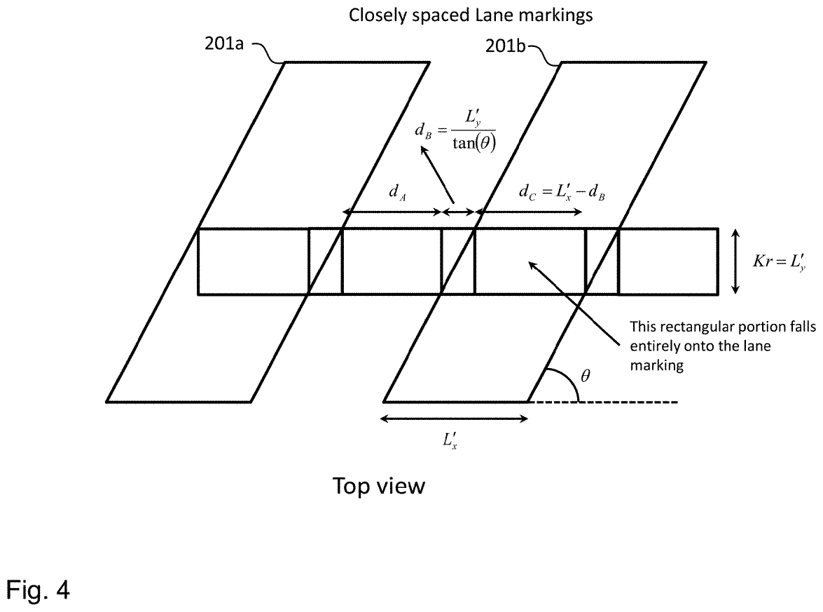

In the embodiment above, the respective widths of the left and right intermediate kernel portions d_{B}(r) is equal to L′_{y}(r). In a further embodiment, d_{B}(r) can be equal to L′_{y}(r)·tan θ, as illustrated in FIG. 4, wherein θ denotes the expected maximum slope of the lane marking. In the embodiment above, θ is 45 degrees. Similarly, in a further embodiment, the width of the central kernel portion d_{C}(r) can be equal to L′ₓ(r)−L′_{y}(r)·tan θ.

In an embodiment, the feature extractor 101 is configured to use kernel #1 shown in FIG. 3 for feature extraction and to determine the plurality of kernel weights of kernel #1 on the basis of the following equations:

$${w}_{A 1} ( r ) = {w}_{A 2} ( r ) = \frac{- 0.5}{{d}_{A} ( r ) \cdot {d}_{B} ( r )} ;$$

$${w}_{B} ( r ) = 0 ;$$

$${w}_{C 1} ( r ) = {w}_{C 2} ( r ) = \frac{1}{{d}_{B} ( r ) \cdot [ {d}_{C 1} ( r ) + {d}_{C 2} ( r ) ]} ,$$

wherein w_{A1}(r) denotes the kernel weight of the left outer kernel portion, w_{A2}(r) denotes the kernel weight of the right outer kernel portion, w_{B}(r) denotes the kernel weight of the left and right intermediate kernel portions, w_{C1}(r) denotes the kernel weight of the left central kernel portion and w_{C2}(r) denotes the kernel weight of the right central kernel portion. Kernel #1 is especially suited for detecting the difference of the average intensity between the lane marking and its surroundings.

Alternatively or additionally, the feature extractor 101 can be configured to use kernel #2 shown in FIG. 3 for feature extraction and to determine the plurality of kernel weights of kernel #2 on the basis of the following equations:

$${w}_{A 1} ( r ) = {w}_{A 2} ( r ) = 0 ; {w}_{B} ( r ) = 0 ;$$

$${w}_{C 1} ( r ) = \frac{1}{{d}_{B} ( r ) \cdot {d}_{C 1} ( r )} ;$$

$${w}_{C 2} ( r ) = \frac{- 1}{{d}_{B} ( r ) \cdot {d}_{C 2} ( r )} ,$$

Kernel #2, is especially suited for detecting the uniformity or intensity in the region of the lane marking.

Alternatively or additionally, the feature extractor 101 can be configured to use kernel #3 shown in FIG. 3 for feature extraction and to determine the plurality of kernel weights of kernel #3 on the basis of the following equations:

$${w}_{A 1} ( r ) = \frac{- 1}{{d}_{A} ( r ) \cdot {d}_{B} ( r )} ;$$

$${w}_{A 2} ( r ) = {w}_{B} ( r ) = 0 ;$$

$${w}_{C 1} ( r ) = {w}_{C 2} ( r ) = \frac{1}{{d}_{B} ( r ) \cdot [ {d}_{C 1} ( r ) + {d}_{C 2} ( r ) ]} ,$$

Kernel #3 is especially suited for detecting the difference between the mean intensity of the lane and road surface to the left of the lane markers.

Alternatively or additionally, the feature extractor 101 can be configured to use kernel #4 shown in FIG. 3 for feature extraction and to determine the plurality of kernel weights of kernel #4 on the basis of the following equations:

$${w}_{A 2} ( r ) = \frac{- 1}{{d}_{A} ( r ) \cdot {d}_{B} ( r )} ; {w}_{A 1} ( r ) = {w}_{B} ( r ) = 0 ;$$

$${w}_{C 1} ( r ) = {w}_{C 2} ( r ) = \frac{1}{{d}_{B} ( r ) \cdot [ {d}_{C 1} ( r ) + {d}_{C 2} ( r ) ]} ,$$

Kernel #3 is especially suited for detecting the difference between the mean intensity of the lane and road surface to the right of the lane markers.

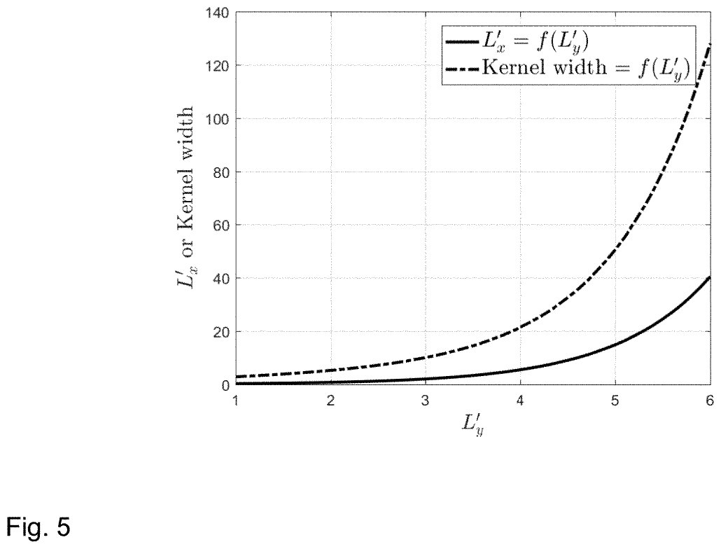

FIG. 5 shows a diagram of two graphs illustrating the “non-linear” kernel width adjustment implemented in the feature extractor 101 of the ADAS 100 according to an embodiment. As already described above, the non-linear scaling of the horizontal to vertical ratio of the kernel's sections illustrated in FIG. 5 allows addressing the problem of increased contribution of camera noise for features being at a larger distance and, thus, having a smaller size.

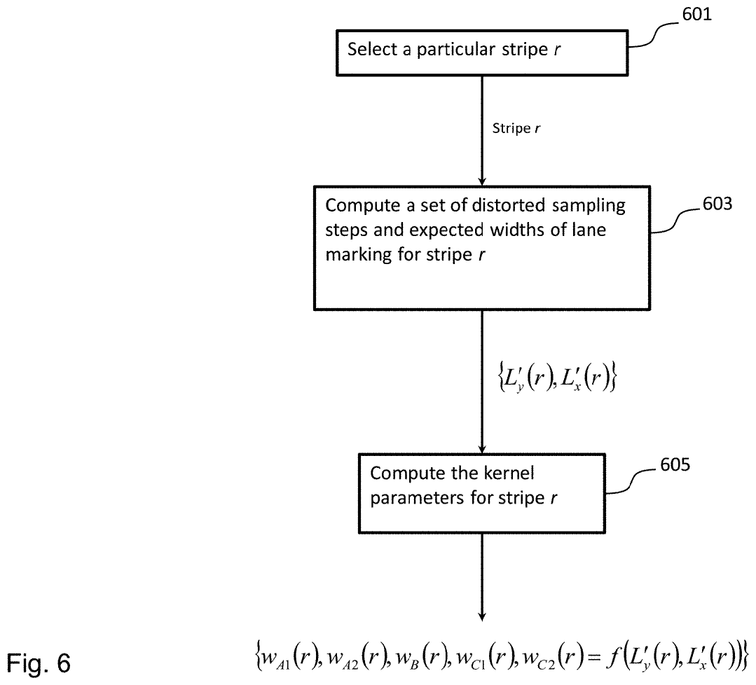

FIG. 6 shows a schematic diagram illustrating processing steps implemented in the feature extractor 101 of the ADAS 100 according to an embodiment. In a step 601 a first or the next horizontal stripe to be processed is selected (identified by the horizontal stripe identifier r). In a step 603 a distorted height L′_{y}(r) and a distorted expected width L′ₓ(r) of the lane marking is determined for the selected stripe r. On the basis of the distorted height L′_{y}(r) and the distorted expected width L′ₓ(r) the weights of the adjustable kernel are determined for the selected stripe r in a step 605, namely w_{A1}(r), w_{A2}(r), w_{B}(r), w_{C1}(r) and w_{C2}(r).

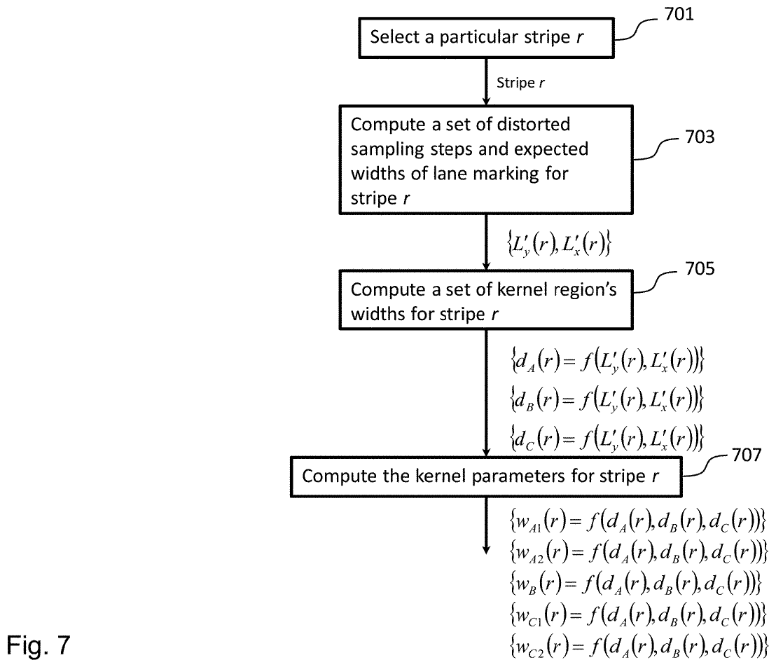

FIG. 7 shows a schematic diagram illustrating processing steps implemented in the feature extractor 101 of the ADAS 100 according to a further embodiment. In a step 701 a first or the next horizontal stripe to be processed is selected (identified by the horizontal stripe identifier r). In a step 703 a distorted height L′_{y}(r) and a distorted expected width L′ₓ(r) of the lane marking is determined for the selected stripe r. On the basis of the distorted height L′_{y}(r) and the distorted expected width L′ₓ(r) the horizontal widths of the different regions of the adjustable kernel are determined for the selected stripe r in a step 705, namely d_{A}(r), d_{B}(r), d_{C1}(r) and d_{C2}(r). On the basis of the horizontal widths of the different regions of the adjustable kernel the weights of the adjustable kernel are determined for the selected stripe r in a step 707, namely w_{A1}(r), w_{A2}(r), w_{B}(r), w_{C1}(r) and w_{C2}(r).

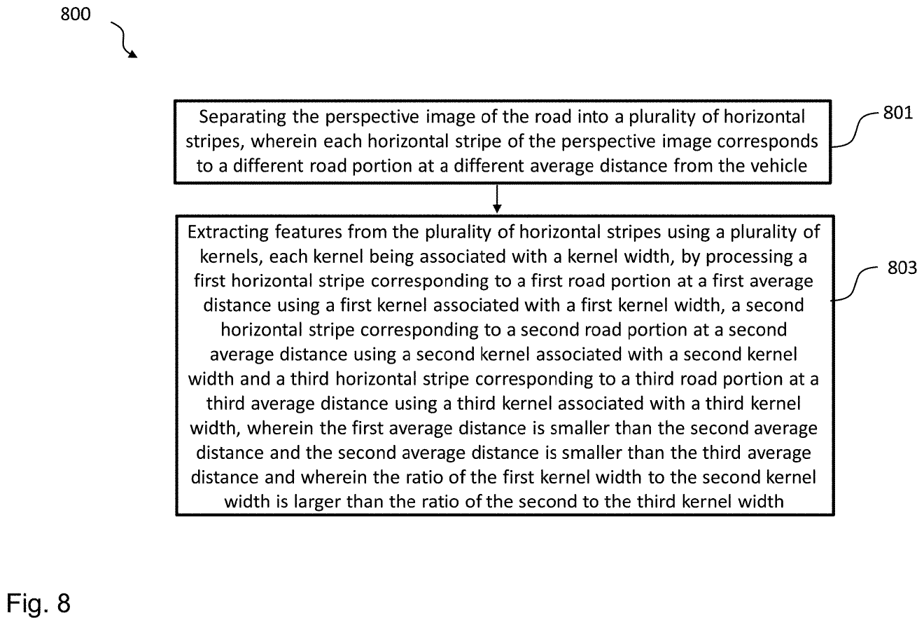

FIG. 8 shows a schematic diagram illustrating a corresponding method 800 of operating the advanced driver assistance system 100 according to an embodiment. The method 800 comprises a first step 801 of separating or partitioning the perspective image of the road into a plurality of horizontal stripes, wherein each horizontal stripe of the perspective image corresponds to a different road portion at a different average distance from the vehicle. Moreover, the method 800 comprises a second step 803 of extracting features from the plurality of horizontal stripes using a plurality of kernels, each kernel being associated with a kernel width, by processing a first horizontal stripe corresponding to a first road portion at a first average distance using a first kernel associated with a first kernel width, a second horizontal stripe corresponding to a second road portion at a second average distance using a second kernel associated with a second kernel width and a third horizontal stripe corresponding to a third road portion at a third average distance using a third kernel associated with a third kernel width, wherein the first average distance is smaller than the second average distance and the second average distance is smaller than the third average distance and wherein the ratio of the first kernel width to the second kernel width is larger than the ratio of the second kernel width to the third kernel width.

While a particular feature or aspect of the disclosure may have been disclosed with respect to only one of several implementations or embodiments, such a feature or aspect may be combined with one or more further features or aspects of the other implementations or embodiments as may be desired or advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives thereof may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the invention beyond those described herein. While the invention has been described with reference to one or more particular embodiments, those skilled in the art recognize that many changes may be made thereto without departing from the scope of the invention. It is therefore to be understood that within the scope of the appended claims and their equivalents, the invention may be practiced otherwise than as specifically described herein.

What is claimed is:

1. An advanced driver assistance system for a vehicle, the advanced driver assistance system being configured to detect lane markings in a perspective image of a road in front of the vehicle, wherein the advanced driver assistance system comprises:
a feature extractor configured to separate the perspective image of the road into a plurality of horizontal stripes, wherein each horizontal stripe of the perspective image corresponds to a different road portion at a different average distance from the vehicle, wherein the feature extractor is further configured to extract features from the plurality of horizontal stripes using a plurality of kernels, each kernel being associated with a kernel width, by processing a first horizontal stripe corresponding to a first road portion at a first average distance using a first kernel associated with a first kernel width, a second horizontal stripe corresponding to a second road portion at a second average distance using a second kernel associated with a second kernel width and a third horizontal stripe corresponding to a third road portion at a third average distance using a third kernel associated with a third kernel width, wherein the first average distance is smaller than the second average distance and the second average distance is smaller than the third average distance and wherein the ratio of the first kernel width to the second kernel width is larger than the ratio of the second kernel width to the third kernel width.

2. The system of claim 1, wherein the first horizontal stripe is adjacent to the second horizontal stripe and the second horizontal stripe is adjacent to the third horizontal stripe.

3. The system of claim 1, wherein each kernel of the plurality of kernels is defined by a plurality of kernel weights and wherein each kernel comprises left and right outer kernel portions, left and right intermediate kernel portions and a central kernel portion, including left and right central kernel portions, wherein for each kernel the associated kernel width is the width of the whole kernel.

4. The system of claim 3, wherein for detecting a feature the feature extractor is further configured to determine for each horizontal stripe a respective average intensity in the left and right central kernel portions, the left and right intermediate kernel portions and the left and right outer kernel portions using a respective convolution operation and to compare a respective result of the respective convolution operation with a respective threshold value.

5. The system of claim 1, wherein for a currently processed horizontal stripe identified by a stripe index r the feature extractor is configured to determine the width of the central kernel portion d_{C}(r), the widths of the left and right intermediate kernel portions d_{B}(r) and the widths of the left and right outer kernel portions d_{A}(r) on the basis of the following equations:
d_{A}(r)=L′ₓ(r); d_{B}(r)=L′_{y}(r); d_{C}(r)=d_{A}(r)−d_{B}(r)+1; d_{C1}(r)=d_{C2}(r)=d_{C}(r)/2,
Kr(r)=d_{B}(r)=L′_{y}(r); d_{C}(r)≥1,
wherein L′ₓ(r) denotes a distorted expected width of the lane marking, L′_{y}(r) denotes a height of the currently processed horizontal stripe, d_{C1}(r) denotes a width of the left central kernel portion, d_{C2}(r) denotes a width of the right central kernel portion and Kr(r) denotes the height of the currently processed horizontal stripe.

6. The system of claim 5, wherein for the currently processed horizontal stripe identified by the stripe index r the feature extractor is configured to determine the plurality of kernel weights on the basis of the following equations:
$${w}_{A 1} ( r ) = {w}_{A 2} ( r ) = \frac{- 0.5}{{d}_{A} ( r ) \cdot {d}_{B} ( r )} ; {w}_{B} ( r ) = 0 ;$$
$${w}_{C 1} ( r ) = {w}_{C 2} ( r ) = \frac{1}{{d}_{B} ( r ) \cdot [ {d}_{C 1} ( r ) + {d}_{C 2} ( r ) ]} ,$$
wherein w_{A1}(r) denotes the kernel weight of the left outer kernel portion, w_{A2}(r) denotes the kernel weight of the right outer kernel portion, w_{B}(r) denotes the kernel weight of the left and right intermediate kernel portions, w_{C1}(r) denotes the kernel weight of the left central kernel portion and w_{C2}(r) denotes the kernel weight of the right central kernel portion.

7. The system of claim 5, wherein for the currently processed horizontal stripe identified by the stripe index r the feature extractor is configured to determine the plurality of kernel weights on the basis of the following equations:
$${w}_{A 1} ( r ) = {w}_{A 2} ( r ) = 0 ; {w}_{B} ( r ) = 0 ;$$
$${w}_{C 1} ( r ) = \frac{1}{{d}_{B} ( r ) \cdot {d}_{C 1} ( r )} ; {w}_{C 2} ( r ) = \frac{- 1}{{d}_{B} ( r ) \cdot {d}_{C 1} ( r )} ,$$
wherein w_{A1}(r) denotes the kernel weight of the left outer kernel portion, w_{A2}(r) denotes the kernel weight of the right outer kernel portion, w_{B}(r) denotes the kernel weight of the left and right intermediate kernel portions, w_{C1}(r) denotes the kernel weight of the left central kernel portion and w_{C2}(r) denotes the kernel weight of the right central kernel portion.

8. The system of claim 5, wherein for the currently processed horizontal stripe identified by the stripe index r the feature extractor is configured to determine the plurality of kernel weights on the basis of the following equations:
$${w}_{A 1} ( r ) = \frac{- 1}{{d}_{A} ( r ) \cdot {d}_{B} ( r )} ;$$
$${w}_{A 2} ( r ) = {w}_{B} ( r ) = 0 ;$$
$${w}_{C 1} ( r ) = {w}_{C 2} ( r ) = \frac{1}{{d}_{B} ( r ) \cdot [ {d}_{C 1} ( r ) + {d}_{C 2} ( r ) ]} ,$$
wherein w_{A1}(r) denotes the kernel weight of the left outer kernel portion, w_{A2}(r) denotes the kernel weight of the right outer kernel portion, w_{B}(r) denotes the kernel weight of the left and right intermediate kernel portions, w_{C1}(r) denotes the kernel weight of the left central kernel portion and w_{C2}(r) denotes the kernel weight of the right central kernel portion.

9. The system of claim 5, wherein for the currently processed horizontal stripe identified by the stripe index r the feature extractor is configured to determine the plurality of kernel weights on the basis of the following equations:
$${w}_{A 2} ( r ) = \frac{- 1}{{d}_{A} ( r ) \cdot {d}_{B} ( r )} ;$$
$${w}_{A 1} ( r ) = {w}_{B} ( r ) = 0 ;$$
$${w}_{C 1} ( r ) = {w}_{C 2} ( r ) = \frac{1}{{d}_{B} ( r ) \cdot [ {d}_{C 1} ( r ) + {d}_{C 2} ( r ) ]} ,$$
wherein w_{A1}(r) denotes the kernel weight of the left outer kernel portion, w_{A2}(r) denotes the kernel weight of the right outer kernel portion, w_{B}(r) denotes the kernel weight of the left and right intermediate kernel portions, w_{C1}(r) denotes the kernel weight of the left central kernel portion and w_{C2}(r) denotes the kernel weight of the right central kernel portion.

10. The system of claim 5, wherein for the currently processed horizontal stripe identified by the stripe index r the feature extractor is configured to determine the plurality of kernel weights on the basis of the distorted expected width of the lane marking L′ₓ(r) and the height of the currently processed horizontal stripe L′_{y}(r).

11. The system of claim 5, wherein for the currently processed horizontal stripe identified by the stripe index r the feature extractor is configured to determine the width of the central kernel portion d_{C}(r), the widths of the left and right intermediate kernel portions d_{B}(r) and the widths of the left and right outer kernel portions d_{A}(r) on the basis of the distorted expected width of the lane marking L′ₓ(r) and the height of the currently processed horizontal stripe L′f_{y}(r) and to determine the plurality of kernel weights on the basis of the width of the central kernel portion d_{C}(r), the widths of the left and right intermediate kernel portions d_{B}(r) and the widths of the left and right outer kernel portions d_{A}(r).

12. The system of claim 1, wherein the system further comprises a stereo camera configured to provide the perspective image of the road in front of the vehicle as a stereo image having a first channel and a second channel.

13. The system of claim 12, wherein the feature extractor is configured to independently extract features from the first channel of the stereo image and the second channel of the stereo image and wherein the system further comprises a unit configured to determine those features, which have been extracted from both the first channel and the second channel of the stereo image.

14. A method of operating an advanced driver assistance system for a vehicle, the advanced driver assistance system being configured to detect lane markings in a perspective image of a road in front of the vehicle, wherein the method comprises:
separating the perspective image of the road into a plurality of horizontal stripes, wherein each horizontal stripe of the perspective image corresponds to a different road portion at a different average distance from the vehicle; and
extracting features from the plurality of horizontal stripes using a plurality of kernels, each kernel being associated with a kernel width, by processing a first horizontal stripe corresponding to a first road portion at a first average distance using a first kernel associated with a first kernel width, a second horizontal stripe corresponding to a second road portion at a second average distance using a second kernel associated with a second kernel width and a third horizontal stripe corresponding to a third road portion at a third average distance using a third kernel associated with a third kernel width, wherein the first average distance is smaller than the second average distance and the second average distance is smaller than the third average distance and wherein the ratio of the first kernel width to the second kernel width is larger than the ratio of the second kernel width to the third kernel width.

15. A non-transitory computer-readable medium comprising program code which, when executed by a processor, causes the method of claim 14 to be performed.
